(19) United States
(12) Patent Application Publication
(10) Pub. No.: US 2012/0240439 A1
(43) Pub. Date: Sep. 27, 2012

(54) Sheet of Storage Components with Identifier Plaques

(75) Inventor: Lynn Marie Picinich, Sun City West, AZ (US)

(73) Assignee: Lynn Marie Picinich, Phoenix, AZ (US)

(21) Appl. No.: 13/417,462

(22) Filed: Mar. 12, 2012

Related U.S. Application Data
(60) Provisional application No. 61/465,865, filed on Mar. 25, 2011.

(51) Int. Cl. G09F 3/18

(52) U.S. Cl. 40/642.02

(57) ABSTRACT

Two sheets of polyethylene are placed one behind the other and sealed together with heat or adhesive along multiple horizontal seams and one (1) vertical seam forming multiple individual cavities and provides a side opening for identifier plaques. The front polyethylene panel has cutouts. An adhesive layer is applied to the back of the rear polyethylene panel and a sheet of paper is applied to the adhesive layer to help keep the adhesive in place until removed and the storage component is adhered to a surface. The polyethylene sheets are translucent or transparent and allow the information displayed on identifier plaques to be seen clearly and also horizontally because of the horizontal pockets. The identifier plaque material is firm so it may be printed or engraved and inserted into cavities. These identifier plaques can easily be inserted and remove and re-inserted into the cavities.

### CROSS REFERENCE

Provisional Patent Application U.S. PTO#: 61465865 Mar. 25, 2011

### STATEMENT OF FEDERAL SPONSORSHIP

Not Applicable

### SEQUENCE LISTING

Not Applicable

### BACKGROUND

The Patent Classification is D19/32. The major classification is D19 Office Supplies; Artists and Teachers Materials. The sub-classification is D19/32 Element or attachment.

There is a need for an organizational tool to easily and efficiently re-order the labeling on the outside of a loose-leaf binder in a timely manner.

Most loose-leaf binders only have one (1) vertical pocket and vertical label on the spine that identifies the contents in the loose-leaf binder. This vertical pocket only allows the user to insert one (1) identifier label that is usually read vertically. If there are multiple categories in one (1) loose-leaf binder then labeling the contents becomes more difficult, especially if there is a change and then re-labeling and re-identifying the contents becomes time consuming when the user wants to keep the identification labels current.

In the fast-paced business, school, and personal environments there is a need to find documents filed in loose-leaf binders fast and efficiently; especially, if there are multiple categories filed in a binder that is within a series of loose-leaf binders. So, when multiple categories are filed in one (1) binder and will have additional information added or subtracted in a category, there needs to be an easy and efficient way to re-label the outside of the binders.

When documents in a category expand or contract this could have an effect on the amount of space used by each category and this expansion or contraction could change the number of the binders in the series. Thus, the labeling on the outside of the loose-leaf binder series could change.

### BRIEF SUMMARY OF THE INVENTION

The sheet of storage components is an organizational tool or apparatus used to identify a loose-leaf binder's category contents or other storage container contents. The sheet of storage components has multiple individual storage cavities with side openings to receive identifier plaques. These individual storage cavities are horizontal to the spine surface and are stacked one on top of another.

The sheet of storage components is then attached to the spine of a loose-leaf binder or other storage container and identifier plaques are inserted into the individual cavities to identify the content categories of a binder or container.

The label information on the identifier plaques is displayed horizontally for quick and easy identification. The labels are displayed in a professional and uniform style.

Each individual storage cavity can accept an identifier plaque and the plaques can easily be inserted and removed and re-inserted for an efficient identification of the re-organized content.

Two sheets of polyethylene are placed one behind the other and sealed together with heat or adhesive along multiple horizontal seams and one (1) vertical seam forming multiple individual cavities and provides a side opening for the insertion of identifier plaques. The front polyethylene panel has cutouts. An adhesive layer is applied to the back of the rear polyethylene panel and a sheet of paper is applied to the adhesive layer to help keep the adhesive in place until the paper is removed and the storage component is adhered to a surface.

The polyethylene sheets are translucent or transparent and allow the information displayed on identifier plaques to be visible and readable from the individual storage cavities.

The identifier plaque material can be made of plastic, metal, paper, fabric, wood, glass or any of these material's derivatives.

The identifier plaque material is firm so it may be inserted into the cavities. These identifier plaques can easily be inserted and removed and re-inserted into the cavities. The identifier plaques have a removal hole on its right side. By placing the end of a paper clip in the removal hole the identifier plaque can easily be removed from its storage cavity.

### BRIEF DESCRIPTION OF THE DRAWINGS

FIG. 1 is a side perspective view of a loose-leaf binder with a binder spine that has an attached sheet of storage components made up of individual storage cavities along with identifier plaques.

FIG. 2 is a front elevation view of an assembled sheet of storage components along with identifier plaques for each storage cavity.

FIG. 3 is a side perspective view of the layers of a non-assembled sheet of storage components' seams, front panel, rear panel, adhesive layer, and paper panel.

### DETAILED DESCRIPTION OF THE INVENTION

The drawings contain numeric reference characters that correspond to specific elements and these numeric references are the same throughout the different drawings.

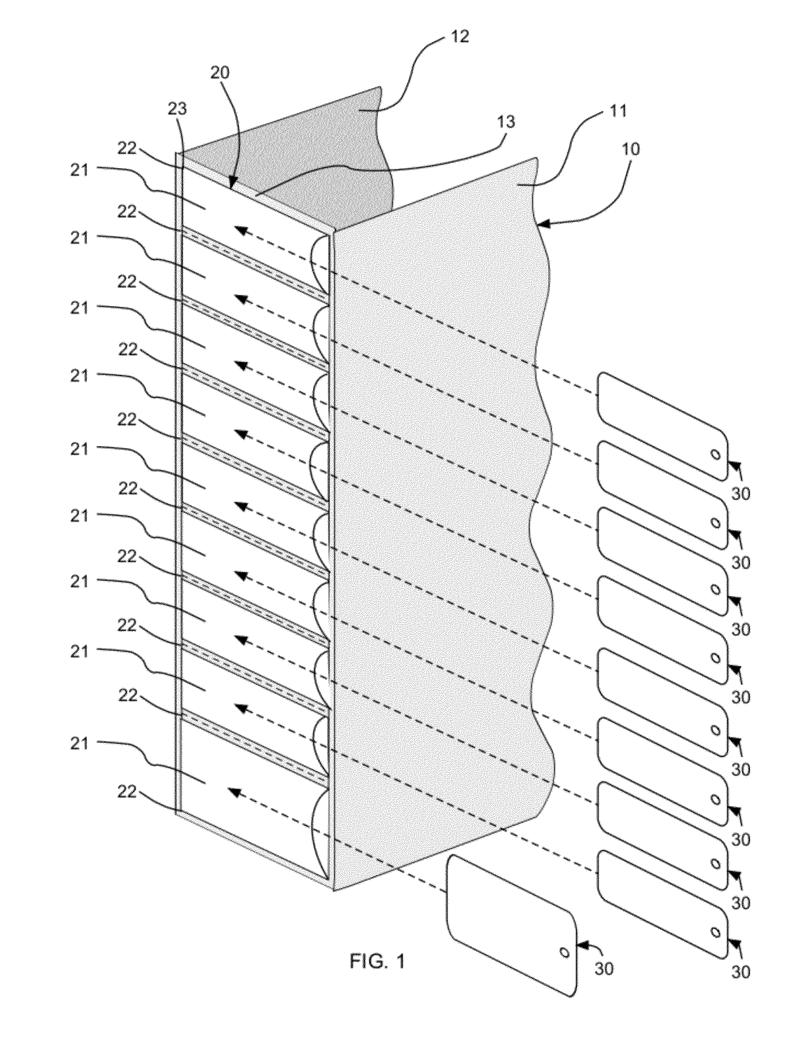

FIG. 1 is a side perspective view and has a loose-leaf binder 10 having a front cover 11 and back cover 12 and a binder spine surface 13. A sheet of storage components 20 is attached to the binder spine surface 13 and has multiple individual storage cavities 21 which are horizontally stacked one on top of another. Individual storage cavities 21 are formed when horizontal seams 22 are placed at horizontal intervals along with a vertical seam 23 along the left edge from top to bottom. Horizontal seams 22 and vertical seam 23 are sealed with some sealing mechanism such as heat or adhesive. Individual storage cavities 21 are generally flat, planar, and rectangular in shape and horizontal to the spine surface 13 in front view. Identifier plaques 30 slide in and out of the storage cavities 21.

Sheet of storage components 20 could be affixed or coupled vertically to the outer surface of a binder's spine 13 or any other storage container. Sheet of storage components 20 is at least partially defined by said outer surface of said binder's spine surface 13.

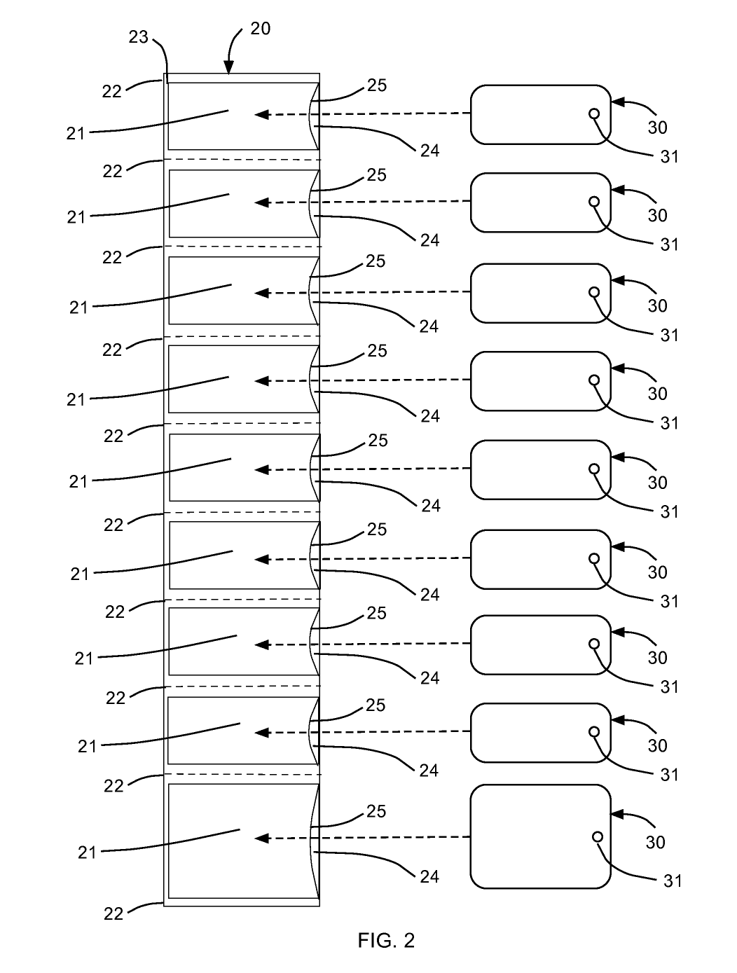

FIG. 2 is a front elevation view and shows a sheet of storage components 20 with individual storage cavities 21 which are horizontally stacked one on top of another. Individual storage cavities 21 are formed when horizontal seams 22 are placed at horizontal intervals along with a vertical seam 23 along the left edge from top to bottom forming individual storage cavities 21 with side openings 24 on the right side. Storage cavities 21 have cut outs 25 on right side. Horizontal seams 22 and vertical seam 23 are sealed with some sealing mechanism such as heat or adhesive. Individual storage cavities 21 are generally flat, planar, and rectangular in shape and horizontal in front view. Identifier plaques 30 slide in and out of the storage cavities 21. Identifier plaques 30 have a removal hole 31 on the right side.

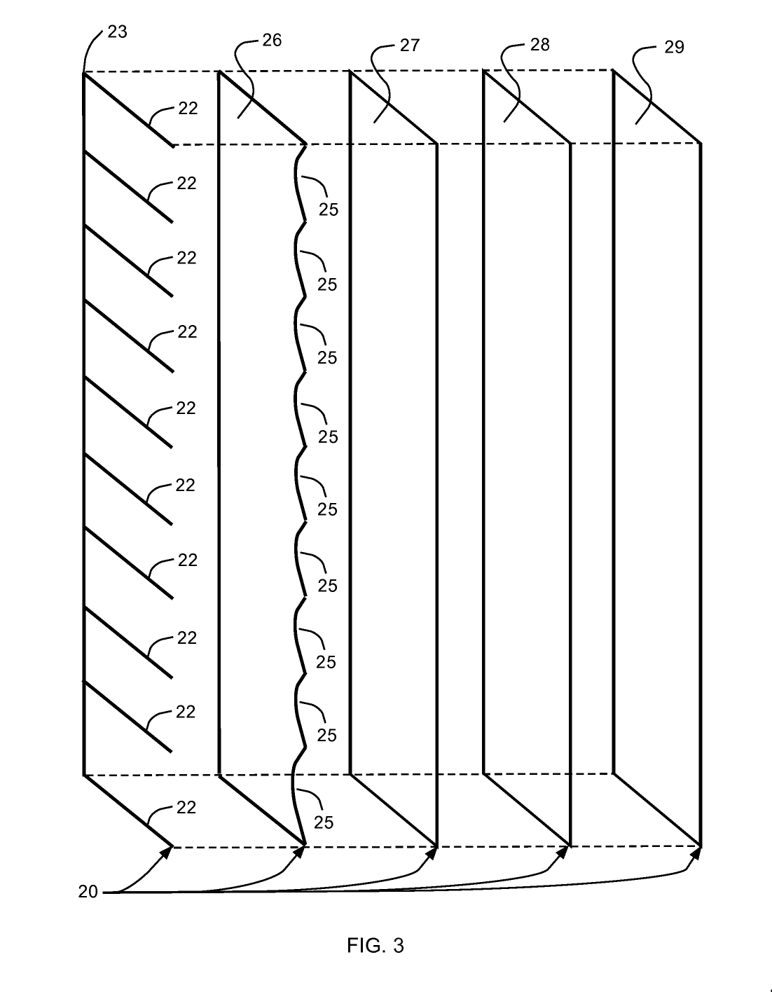

FIG. 3 shows a side perspective view of the layers of a non-assembled sheet of storage components 20. The non-assembled sheet of storage components 20 consists of horizontal seams 22, vertical seam 23, storage component front panel 26 with cutouts 25, a storage component rear panel 27, an adhesive layer 28, and a paper panel 29. Horizontal seams 22 and vertical seam 23 bond the storage component front panel 26 and the storage component rear panel 27 to each other. An adhesive layer 28 is applied to the back of the storage component rear panel 27 and a paper panel 29 protects the adhesive layer 28.

1. The above-described apparatus can be used as an identification mechanism on the outside spine of a binder or any other storage container to identify a dynamic organizational structure contained within.

2. The apparatus comprises a series of individual horizontal storage cavities that can hold multiple identifier plaques to identify the contents in a binder and the information on the identifier plaques is displayed horizontally for easy recognition of the wording.

3. The apparatus allows the identifier plaques to be inserted, removed, and re-inserted easily.
